(19) United States
(12) Patent Application Publication
(10) Pub. No.: US 2025/0083404 A1
(43) Pub. Date: Mar. 13, 2025

(54) METAL COMPOSITE STRUCTURE, PROCESSING METHOD OF THE SAME, AND METAL FRAME HAVING THE SAME

(71) Applicant: Fulian Yuzhan Precision Technology Co., Ltd., Shenzhen (CN)

(72) Inventors: Xin HUANG, Shenzhen (CN); Sheng-Hao HONG, Shenzhen (CN); Jian-Xiong QIAN, Shenzhen (CN); Lei ZHU, Shenzhen (CN); Peng XIE, Shenzhen (CN); Xiang-Kun MENG, Shenzhen (CN); Feng FANG, Shenzhen (CN); Hui WU, Shenzhen (CN); Xiao-Hui CHEN, Shenzhen (CN); Shuang-Xu ZHONG, Shenzhen (CN); Ren-Jun YANG, Shenzhen (CN); Chao CHENG, Shenzhen (CN); Zhi-Qiang SHEN, Shenzhen (CN); Ye-An SUN, Shenzhen (CN)

(21) Appl. No.: 18/883,171

(22) Filed: Sep. 12, 2024

(30) Foreign Application Priority Data
Sep. 13, 2023 (CN) 202311185175.X
Jul. 22, 2024 (CN) 202410988266.5

(51) Int. Cl. B32B 3/26; B21D 39/03; B32B 15/01

(52) U.S. Cl. CPC B32B 3/266; B21D 39/034; B32B 15/017

(57) ABSTRACT

The present application provides a processing method of a metal composite structure including a first metal layer and a second metal layer stacked on the first metal layer. The processing method includes the steps of defining a first through hole in the first metal layer, and drilling in the first through hole toward the second metal layer to form a traction hole in the second metal layer. Then, hot melt drilling is performed on a surface of the second metal layer away from the first metal layer toward the first through hole, thereby causing the second metal layer to crack under a traction force of the traction hole to form a second through hole, and a portion of the second metal layer to be melted and squeezed to form a bushing which adheres to at least a portion of a sidewall of the first through hole.

### CROSS-REFERENCE TO RELATED APPLICATION

The present application claims priority to China Application No. 202311185175.X, having a filing date of Sep. 13, 2023, and China Application No. 202410988266.5, having a filing date of Jul. 22, 2024, filed in China National Intellectual Property Administration, the entire contents of which are hereby incorporate by reference.

### FIELD

The subject matter relates to metal processing, and more particularly, to a metal composite structure, a processing method of the metal composite structure, and a metal frame having the metal composite structure.

### BACKGROUND

During the processing of metal casing of electronic products such as mobile phones or computers, through holes (such as button holes or sound holes) need to be defined in the metal casings. In related arts as shown in FIG. 17, when the metal casing 1 is a double-layer structure of metal composite material (such as composite material of titanium alloy 120 and aluminum alloy 110), a through hole 101 may expose the boundary 1010 between the titanium alloy 120 and aluminum alloy 110. When the metal casing 1 is then subjected to a subsequent process such as anode corrosion process, since the aluminum alloy 110 has a higher activity than the titanium alloy 120, cracking may happen at the boundary 1010 between the titanium alloy 120 and aluminum alloy 110 inside the through hole 101, which reduces the quality of the metal casing 1.

Therefore, there is room for improvement within the art.

### SUMMARY

The present application provides a processing method of a metal composite structure including a first metal layer and a second metal layer stacked on the first metal layer. The processing method includes defining a first through hole in the first metal layer, and drilling in the first through hole toward the second metal layer to form a traction hole in the second metal layer. Then, hot melt drilling is performed on a surface of the second metal layer away from the first metal layer toward the first through hole, thereby causing the second metal layer to crack under a traction force of the traction hole to form a second through hole, and a portion of the second metal layer to be melted and squeezed to form a bushing which adheres to at least a portion of a sidewall of the first through hole, thereby obtaining the metal composite structure.

The present application further provides a metal composite structure including a first metal layer and a second metal layer. The first metal layer defines a first through hole, and the first through hole includes a curved hole segment. The second metal layer is stacked on the first metal layer. The second metal layer defines a second through hole by hot melt drilling on the second metal layer, a portion of the second metal layer forms a bushing during the hot melt drilling, and the bushing adheres to a sidewall of the curved hole segment of the first through hole.

The present application further provides a metal frame including the metal composite structure mentioned above.

In the above-mentioned processing method, the metal composite structure, and the metal frame, before the hot melt drilling is performed on the second metal layer, the traction hole is first formed on the surface of the second metal layer facing the first through hole. The traction hole may reduce the internal stress of the second metal layer, such that when a portion of the second metal layer is melted to form the bushing that uniformly adheres to the sidewall of the first through hole, recesses or cracks may be avoided at the surface of the bushing. Thus, liquid and dust are prevented from entering the boundary between the first metal layer and the second metal layer through the first through hole or the second through hole, and cracking may be avoided at the boundary. Thus, the sealing performance and the quality of the metal composite structure is improved.

Other aspects and embodiments of the present disclosure are also expected. The above summary and the following detailed description are not intended to limit the present disclosure to any particular embodiment, but are merely intended to describe some embodiments of the present disclosure.

### BRIEF DESCRIPTION OF THE DRAWINGS

FIG. 1 is a flowchart of a processing method of a metal composite structure according to an embodiment of the present application.

FIG. 2 is a cross-sectional view showing a first metal layer and a second metal layer stacked on the first metal layer according to an embodiment of the present application.

FIG. 3 is a cross-sectional view showing a first through hole being defined in the first metal layer of FIG. 2.

FIG. 4A is a cross-sectional view showing a second through hole being defined in the first metal layer of FIG. 3 to obtain a metal composite.

FIG. 4B is a diagrammatic view of the metal composite structure of FIG. 4A.

FIG. 5 is a sub-flowchart of step S120 of FIG. 1.

FIG. 6 is a cross-sectional view showing an original through hole being defined in the first metal layer of FIG. 2.

FIG. 7 is a cross-sectional view showing a portion of the original through hole of FIG. 6 being enlarged to form a curved hole segment.

FIG. 8 is a cross-sectional view showing a portion of a basic hole segment of FIG. 7 being enlarged to form an observation hole.

FIG. 9 is a cross-sectional view showing a first reference blind hole being defined in the second metal layer of FIG. 8.

FIG. 10 is a cross-sectional view showing the first reference blind hole of FIG. 9 being enlarged to form a dovetail hole.

FIG. 11 is a sub-flowchart of step S140 of FIG. 1.

FIG. 12 is a cross-sectional view showing a traction hole and a second reference blind hole being defined in the second metal layer of FIG. 10.

FIG. 13 is a cross-sectional view showing a portion of the second reference blind hole of FIG. 12 being enlarged to form a sidewall-inclining hole.

FIG. 14 is a cross-sectional view showing a guiding hole being formed in the second metal layer of FIG. 13.

FIG. 15 is a cross-sectional view showing the first metal layer of FIG. 4A being milled to obtain another metal composite structure.

FIG. 16 is a diagrammatic view of a metal frame according to an embodiment of the present application.

FIG. 17 is a diagrammatic view of a metal casing in related arts.

### DETAILED DESCRIPTION

The embodiments of the present disclosure will be described in detail below with reference to the above figures. Throughout the specification, the same or similar components and components having the same or similar functions are denoted by similar reference numerals. The embodiments described herein with respect to the drawings are illustrative, and are used for providing a basic understanding of the present disclosure. The embodiments of the present disclosure should not be interpreted as limitations to the present disclosure.

Implementations of the present disclosure will now be described, by way of embodiments, with reference to the above figures.

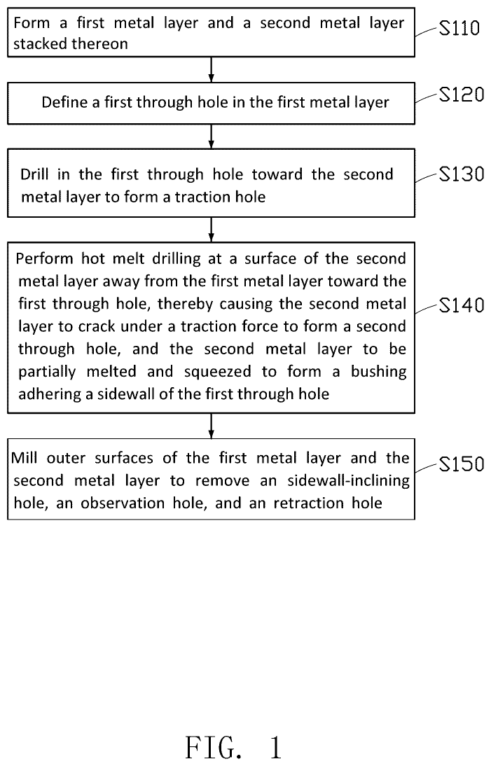

FIG. 1 illustrates a flowchart of a processing method of a metal composite structure 100 in accordance with an embodiment, and the metal composite structure 100 includes a first metal layer 110 and a second metal layer 120. The method is provided by way of embodiments, as there are a variety of ways to carry out the method. Each step shown in FIG. 1 represents one or more processes, methods, or subroutines carried out in the method. Furthermore, the illustrated order of steps may be changed. Additional steps may be added or fewer steps may be utilized, without departing from this disclosure.

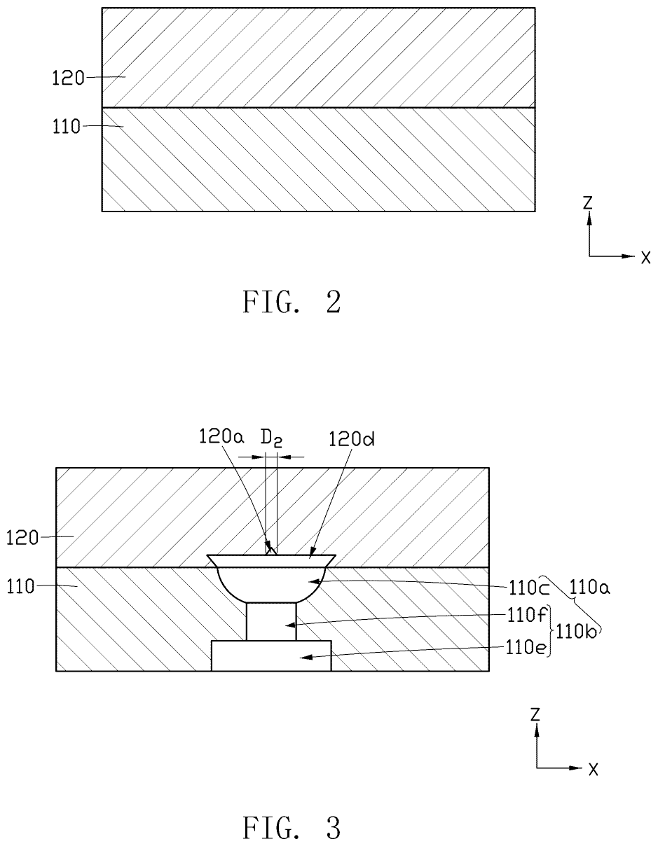

S110, referring to FIG. 2, the first metal layer 110 and the second metal layer 120 stacked on the first metal layer 110 are formed.

Referring to FIG. 2, the first metal layer 110 and the second metal layer 120 cooperatively form a metal assembly. An extending direction of an outer surface of the first metal layer 110 or an outer surface of the second metal layer 120 is defined as X direction. A thickness direction of the metal assembly is defined as Z direction. Ends of the second metal layer 120 may be aligned with ends of the first metal layer 110. In other embodiments, the ends of the second metal layer 120 may also be misaligned with the ends of the first metal layer 110 according to actual needs.

In some embodiments, forming the first metal layer 110 and the second metal layer 120 stacked on the first metal layer 110 may be carried out by: a first metal substrate and a second metal substrate are provided. Then, each of the first metal substrate and the second metal substrate is subjected to anodizing, grinding, sandblasting, and laser cladding, thereby forming the first metal layer 110 and the second metal layer 120. Each of the first metal layer 110 and the second metal layer 120 has micro-pores and micro-protrusions on at least one surface. Then, the second metal layer 120 is stacked on the first metal layer 110, and the first metal layer 110 and the second metal layer 120 stacked thereon are placed into an automatic circulation and transmission tunnel for high temperature treatment. After the high temperature treatment, the first metal layer 110 and the second metal layer 120 are immediately placed into a pressing mechanism, so that the first metal layer 110 and the second metal layer 120 are pressed against each other. As such, the micro protrusions of the second metal layer 120 are pressed into the micropores of the first metal layer 110, and the micro protrusions of the first metal layer 110 are pressed into the micropores of the second metal layer 120, thereby realizing stable connection between the first metal layer 110 and the second metal layer 120. In other embodiments, after the second metal layer 120 is stacked on the first metal layer 110, the first metal layer 110 and the second metal layer 120 may also be connected to each other by screws or fixtures, thereby facilitating the placement of the first metal layer 110 and the second metal layer 120 on a machine tool for subsequent processing.

S120, referring to FIG. 3, a first through hole 110a is defined in the first metal layer 110.

Referring to FIG. 3, the machine tool includes at least one cutting tool for forming the first through hole 110a. The first through hole 110a is connected to the second metal layer 120, indicating that the first through hole 110a extends through the first metal layer 110 in a direction from the first metal layer 110 to the second metal layer 120. Thus, the cutting tool may be inserted through first through hole 110a to process the second metal layer 120. In other embodiments, the first through hole 110a may only extend through a surface of the first metal layer 110 away from the second metal layer 120.

S130, referring to FIG. 3, the first through hole 110a is drilled toward the second metal layer 120 to form a traction hole 120a in the second metal layer 120.

Referring to FIG. 3, the traction hole 120a may reduce internal stress of the second metal layer 120, and recesses or cracks may be avoided at the surface of the second metal layer 120 when the second metal layer 120 cracks during hot melt drilling.

Referring to FIG. 3, in some embodiments, a thickness of the first metal layer 110 in the Z direction may be 1.4 mm to 1.8 mm. Optionally, the thickness of the first metal layer 110 is about 1.5 mm. A thickness of the second metal layer 120 in the Z direction may be 1.8 mm to 2.0 mm, and optionally, the thickness of the second metal layer 120 is about 1.9 mm. A diameter of the traction hole 120a gradually decreases from a direction from the first metal layer 110 to the second metal layer 120. A maximum diameter of the traction hole 120a is denoted as D₂, and 0.5 mm≤D₂≤1.0 mm. For example, D₂ is about 0.5 mm, 0.6 mm, 0.7 mm, 0.8 mm, 0.9 mm, or 1.0 mm. Optionally, D₂ is about 1.0 mm.

The traction hole 120a may be a conical blind hole, and the maximum diameter D₂ of the traction hole 120a refers to the opening diameter of the traction hole 120a.

By setting the maximum diameter of the traction hole 120a, the traction hole 120a may provide uniform traction force to the second metal layer 120 during the hot melt drilling, thereby allowing the cracking of the second metal layer 120 to be uniform, and recesses or cracks may be avoided at the surface of the second metal layer 120.

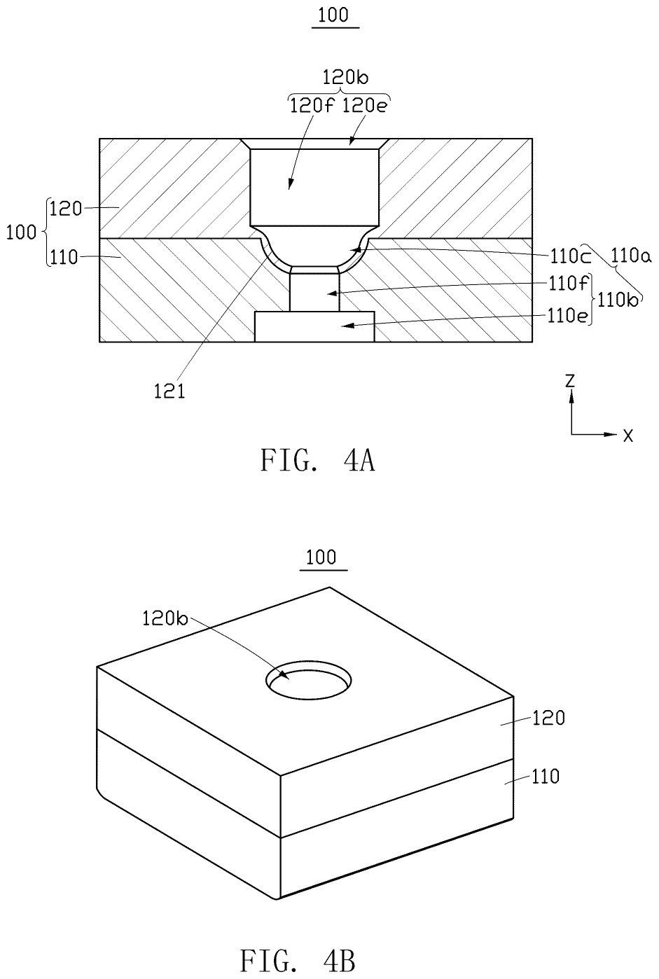

S140, referring to FIGS. 4A and 4B, the hot melt drilling is performed at a surface of the second metal layer 120 away from the first metal layer 110 toward the first through hole 110a, thereby causing the second metal layer 120 to crack under the traction force of the traction hole 120a to form a second through hole 120b. The second metal layer 120 is partially melted and squeezed during the hot melt drilling to form a bushing 121. The bushing 121 adheres at least a portion of the sidewall of the first through hole 110a. Then, the metal composite structure 100 is obtained.

Referring to FIG. 4A, the second through hole 120b extends through the second metal layer 120 in the direction from the second metal layer 120 to the first metal layer 110, and the second metal layer 120 partially extends into the first through hole 110a. Specifically, the second metal layer 120 is partially melted and squeezed during the hot melt drilling to form the bushing 121, and the bushing 121 adheres the sidewall of the first through hole 110a, thereby achieving stable connection between the first metal layer 110 and the second metal layer 120 to form the metal composite structure 100. The bushing 121 may adhere a portion of the sidewall of the first through hole 110a. The bushing 121 may also adhere the entire sidewall of the first through hole 110a.

In some embodiments, before step S140, the metal assembly is first turned over to allow the second metal layer 120 to be located above the first metal layer 110. Then, the cutting tool may perform the hot melt drilling at the surface of the second metal layer 120 in a direction from top to bottom. In other embodiments, the metal assembly may not be turned over, and the cutting tool may perform the hot melt drilling at the surface of the second metal layer 120 in a direction from bottom to top.

In some embodiments, the second through hole 120b and the first through hole 110a are coaxial with each other. The second through hole 120b extends through the middle area of the second metal layer 120, and the first through hole 110a extends through the middle area of the first metal layer 110.

In some embodiments, the first metal layer 110 and the second metal layer 120 may be made of a same material or different materials. For example, each of the first metal layer 110 and the second metal layer 120 is made of aluminum alloy. For example, the first metal layer 110 is made of aluminum material, such as aluminum alloy, and the second metal layer 120 is made of titanium material, such as titanium alloy. The bushing 121 of the titanium alloy covers the boundary between the titanium alloy and the aluminum alloy. Thus, corrosion is avoided at the boundary between the titanium alloy and the aluminum alloy during a possible chemical process, thereby improving the sealing performance of a waterproof hole of the metal composite structure 100.

Referring to FIGS. 3 and 4A, in some embodiments, the first through hole 110a includes a basic hole segment 110b and a curved hole segment 110c connected to the basic hole segment 110b.

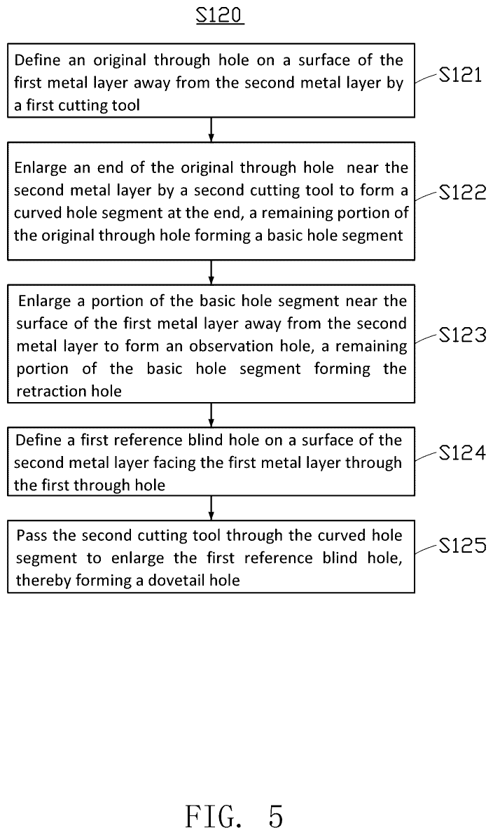

FIG. 5 illustrates a sub-flowchart of a method for defining the first through hole 110a in the first metal layer 110 as described in step S120. The method may begin at S121.

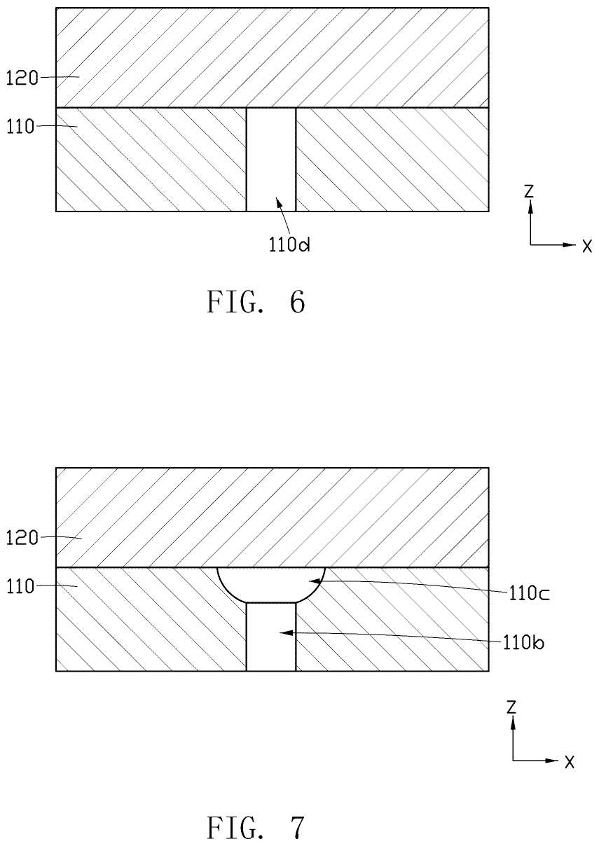

S121, referring to FIG. 6, an original through hole 110d is defined on a surface of the first metal layer 110 away from the second metal layer 120 by a first cutting tool.

Referring to FIG. 6, the original through hole 110d extends through the first metal layer 110 in the direction of the first metal layer 110 toward the second metal layer 120. When viewed from the Z direction, the original through hole 110d is circular. In other embodiments, the original through hole 110d may only penetrate the surface of the first metal layer 110 away from the second metal layer 120, and extend toward the second metal layer 120 by a depth of 0.3 mm to 2 mm. The first cutting tool may be a drill bit, a shallow hole drill, or a toroidal cutter. Optionally, the first cutting tool is a toroidal cutter.

S122, referring to FIG. 7, an end of the original through hole 110d near the second metal layer 120 is enlarged by a second cutting tool, thereby forming the curved hole segment 110c at the end of the original through hole 110d near the second metal layer 120. The remaining portion of the original through hole 110d forms the basic hole segment 110b.

Referring to FIG. 7, the diameter of the curved hole segment 110c is larger than the diameter of the basic hole segment 110b. Since the portion of the original through hole 110d away from the second metal layer 120 is not processed by the second cutting tool, a diameter of the basic hole segment 110b is equal to that of the original through hole 110d. The second cutting tool may be a reamer, a rough boring tool, or a T-shaped tool. Optionally, the second cutting tool is a T-shaped tool. In another embodiment, the diameter of the basic hole segment 110b may also be larger than that of the original through hole 110d.

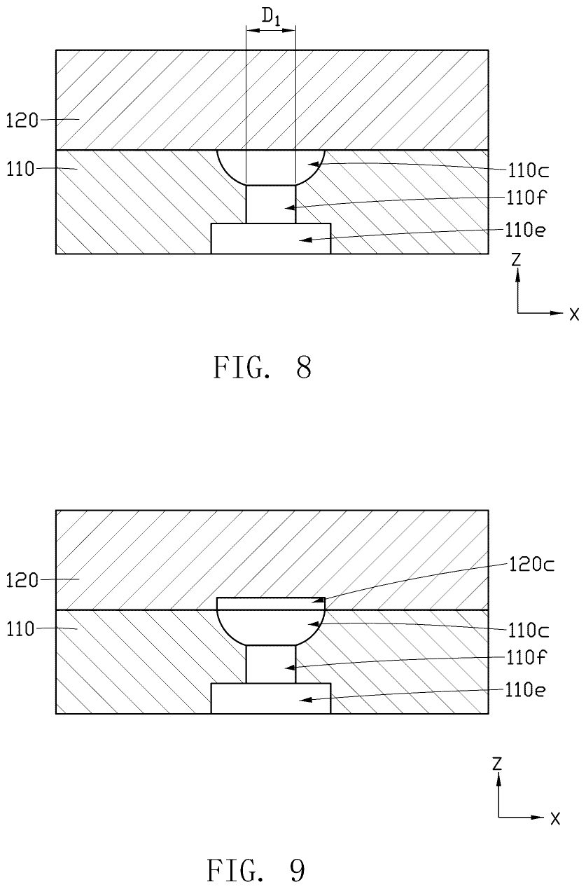

Referring to FIG. 8, in some embodiments, the basic hole segment 110b of the first through hole 110a includes an observation hole 110e and a retraction hole 110f connected to the observation hole 110e. The retraction hole 110f is further connected to the curved hole segment 110c. A diameter of the observation hole 110e is larger than that of the retraction hole 110f, thereby forming a stepped structure between the observation hole 110e and the retraction hole 110f.

Referring to FIG. 5, the method for defining the first through hole 110a in the first metal layer 110 as described in step S120 further includes:

S123, referring to FIG. 8, a portion of the basic hole segment 110b near the surface of the first metal layer 110 away from the second metal layer 120 is enlarged, thereby forming the observation hole 110e at the portion of the basic hole segment 110b near the surface of the first metal layer 110 away from the second metal layer 120. The remaining portion of the basic hole segment 110b forms the retraction hole 110f.

Referring to FIG. 8, a diameter of the retraction hole 110f is equal to a diameter of the basic hole segment 110b. The first cutting tool may be used to perform step S123, and optionally, the toroidal cutter is used to perform step S123. In other embodiments, other cutting tools may also be used to perform step S123.

Therefore, the observation hole 110e facilitates the observation when the cutting tool is used to process the second metal layer 120, thereby improving the processing efficiency of the second metal layer 120.

Referring to FIG. 8, in some embodiments, a maximum diameter of the curved hole segment 110c is 2.07 mm to 2.27 mm. For example, the maximum diameter of the curved hole segment 110c is about 2.07 mm, 2.17 mm, or 2.27 mm. In other embodiments, the maximum diameter of the curved hole segment 110c may also be adjusted to allow the bushing 121 to fully cover thereon, thereby obtaining a waterproof hole.

In some embodiments, the diameter of the curved hole segment 110c gradually decreases from the boundary between the first metal layer 110 and the second metal layer 120 toward the surface of the first metal layer 110 away from the second metal layer 110. A depth of the curved hole segment 110c is 1.0 mm to 1.3 mm. For example, the depth of the curved hole segment 110c is about 1.0 mm, 1.15 mm, 1.25 mm, or 1.3 mm.

In some embodiments, a diameter of the retraction hole 110f is denoted as D₁, and 1.5 mm≤D₁≤1.6 mm. For example, D₁ is about 1.5 mm or 1.6 mm. Optionally, D₁ is about 1.5 mm.

By setting the diameter of the retraction hole 110f, the retraction hole 110f may effectively control the flow rate of a portion of the second metal layer 120 that is melted, thereby allowing the melted portion of the second metal layer 120 to form the bushing 121 that uniformly adheres to the sidewall of the curved hole segment 110c.

During the hot melt drilling, the shape of the curved hole segment 110c may match the curvature formed by the melted second metal layer 120 that is flowing, so that the bushing 121 may better fit and cover the curved hole segment 110c of the first through hole 110a. Since the diameter of the curved hole segment 110c is larger than that of the retraction hole 110f, a material blocking structure is formed, which may prevent the melted portion of the second metal layer 120 from overflowing out of the basic hole segment 110b, thereby preventing the bushing 121 from cracking due to excessive stretching.

Referring to FIG. 5, in some embodiments, the processing method of the metal composite structure 100 further includes the following step.

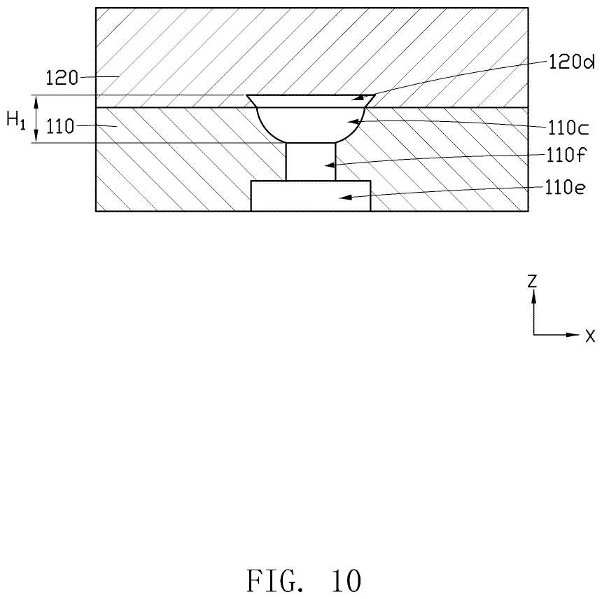

S124, referring to FIG. 9, a first reference blind hole 120c is defined on an inner surface of the second metal layer 120 (the surface of the second metal layer 120 facing the first metal layer 110) through the first through hole 110a.

The step S124 may be performed after step S121, and there is no need to change the cutting tool. That is, the first cutting tool may be used to define the first reference blind hole 120c, thereby improving the machining efficiency. In another embodiment, since the first reference blind hole 120c has a small depth, the step S124 may also be performed after step S122 with the second cutting tool, that is, there is no need to change the second cutting tool. In other embodiments, the step S124 may also be performed by the first cutting tool or the second cutting tool after forming the retraction hole 110f and the observation hole 110e at step S123. That is, after forming the retraction hole 110f and the observation hole 110e, the first cutting tool may be directly used to pass through the observation hole 110e, the retraction hole 110f, and the curved hole segment 110c in sequence to define the first reference blind hole 120c on the inner surface of the second metal layer 120. The enlarged observation hole 110e facilitates observation during the formation of the first reference blind hole 120c, and also facilitates the further processing procedures.

Referring to FIG. 5, in some embodiments, the processing method of the metal composite structure further includes the following step.

S125, referring to FIG. 10, the second cutting tool is used to pass through the curved hole segment 110c to enlarge the first reference blind hole 120c, thereby forming a dovetail hole 120d.

The step S125 is performed after the formation of the curved hole segment 110c at step S122. At this time, there is no need to change the second cutting tool after step S122, and the second cutting tool may be directly fed toward the inner surface of the second metal layer 120 to form the dovetail hole 120d on the inner surface of the second metal layer 120, thereby improving processing efficiency.

In another embodiment, after the formation of the retraction hole 110f and the observation hole 110e at step S123, the first cutting tool may be replaced by the second cutting tool to perform the step S125.

Therefore, the dovetail hole 120d may facilitate the removal of burrs on the sidewall of the retraction hole 110f, and reduce the internal stress on the second metal layer 120. A bottom surface of the dovetail hole 120d may be square or circular, and a diameter of the dovetail hole 120d gradually increases from the direction from the first metal layer 110 to the second metal layer 120.

Referring to FIG. 10, in some embodiments, a sum of the depth of the dovetail hole 120d and the depth of the curved hole segment 110c is denoted as H₁, and 1.15 mm≤H₁≤1.25 mm. For example, H₁ is about 1.15 mm, 1.20 mm, or 1.25 mm. Optionally, H₁ is about 1.20 mm. The depth of the dovetail hole 120d is smaller than the depth of the curved hole segment 110c.

By setting the range of H₁, the melted portion of the second metal layer 120 may uniformly adhere to the sidewall of the first through hole 110a during the hot melt drilling.

In some embodiments, the formation of the traction hole 120a at step S130 may be carried out by passing a third cutting tool sequentially through the basic hole segment 110b and the curved hole segment 110c, and defining the traction hole 120a on the bottom surface of the dovetail hole 120d.

The third cutting tool may be a center drill or a sharp-edged knife. Optionally, the third cutting tool is a sharp-edged knife.

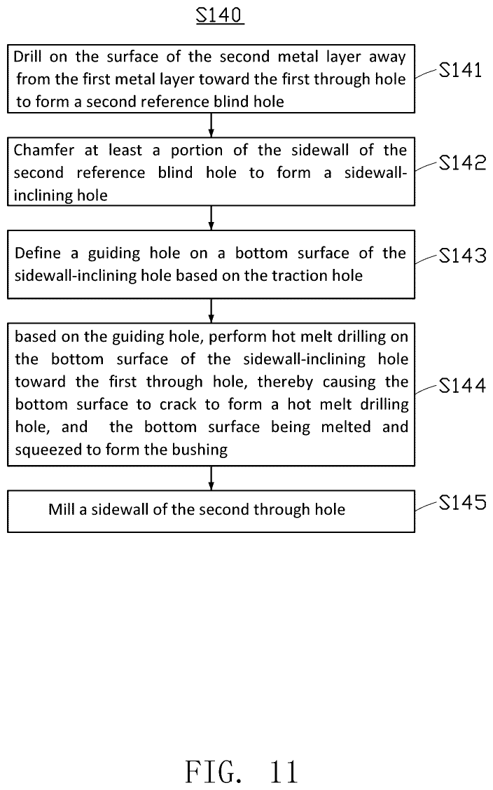

Referring to FIG. 4A, in some embodiments, the second through hole 120b includes a sidewall-inclining hole 120e and a hot melt drilling hole 120f. FIG. 11 illustrates a sub-flowchart of a method for forming the second through hole 120b and the bushing 121 as described in step S140. The method may begin at S141.

S141, referring to FIG. 12, the surface of the second metal layer 120 away from the first metal layer 110 is drilled toward the first through hole 110a to form a second reference blind hole 120g.

The step S141 may be performed by a drill bit, a shallow hole drill, or a toroidal cutter. Optionally, a toroidal cutter is used.

The step S141 may be performed after step 130. After the step 130, the metal assembly may be turned over to allow the second metal layer 120 to be located above the first metal layer 110, and the cutting tool may be changed for a new one, which may fed from top to bottom to drill on the second metal layer 120 to form the second reference blind hole 120g. In other embodiments, the metal assembly may not be turned over, and the cutting tool may drill on the second metal layer 120 from bottom to top.

In other embodiments, the cutting tool used at step S141 may also be the same as the first cutting tool. Optionally, the step S141 may also be performed after completing step S123 by the first cutting tool, and there is no need to change the first cutting tool. The metal assembly is turned over to allow the second metal layer 120 to be located above the first metal layer 110, and the first cutting tool may feed from top to bottom to drill on the second metal layer 120 to form the second reference blind hole 120g. In other embodiments, the metal assembly may also not be turned over, and the first cutting tool may drill on the second metal layer 120 from bottom to top.

When viewed from the Z direction, the second reference blind hole 120g may be circular, square, rectangular or elliptical.

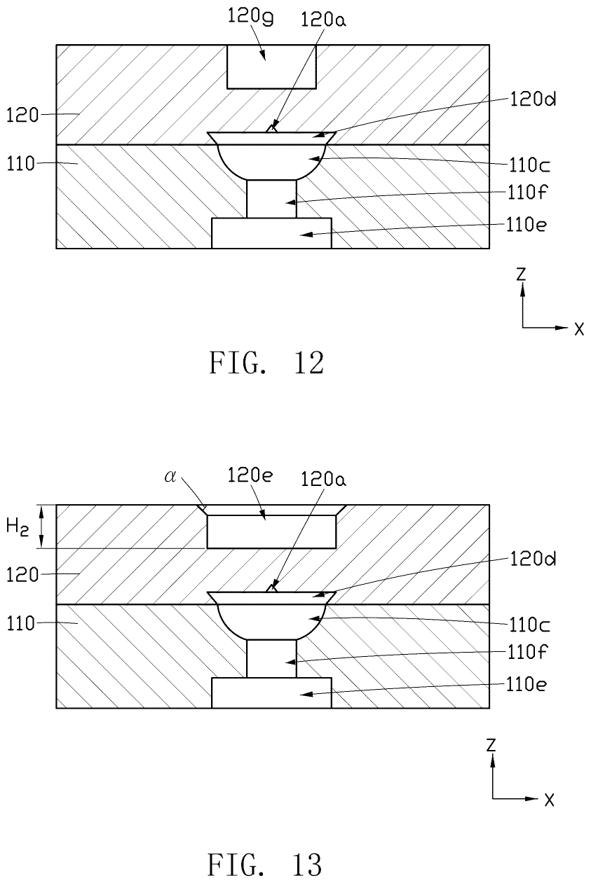

S142, referring to FIG. 13, at least a portion of the sidewall of the second reference blind hole 120g is chamfered to form the sidewall-inclining hole 120e.

Referring to FIG. 13, an opening size (minimum size) of the sidewall-inclining hole 120e is equal to the diameter of the observation hole 110e. A chamfer cutter may be used to perform the step S142.

Referring to FIG. 13, in some embodiments, an inclining angle of the sidewall of the sidewall-inclining hole 120e relative to the top surface of the second metal layer 120 is denoted as α, and α is from 30 degrees to 45 degrees. For example, α may be about 30 degrees, 35 degrees, 40 degrees, or 45 degrees. Optionally, a is about 30 degrees. In the embodiment, the sidewall-inclining hole 120e includes a conical through hole segment located at the top and a vertical hole segment located at the bottom and connected to the conical through hole segment. Wherein, a is an angle between the sidewall of the conical through hole segment of the sidewall-inclining hole 120e and the top surface of the second metal layer 120.

By setting the opening size of the sidewall-inclining hole 120e, the melted portion of the second metal layer 120 may be uniformly squeezed during the hot melt drilling.

In some embodiments, a depth of the sidewall-inclining hole 120e (i.e., a depth of the second reference blind hole 120g) is denoted as H₂, and 0.6 mm≤H₂≤0.7 mm. For example, H₂ may be about 0.6 mm, 0.65 mm, or 0.7 mm. Optionally, H₂ is about 0.6 mm.

By setting the depth of the sidewall-inclining hole 120e, the volume of the second metal layer 120 that is melted during the hot melt drill may be reduced, which may reduce the internal stress of the second metal layer 120.

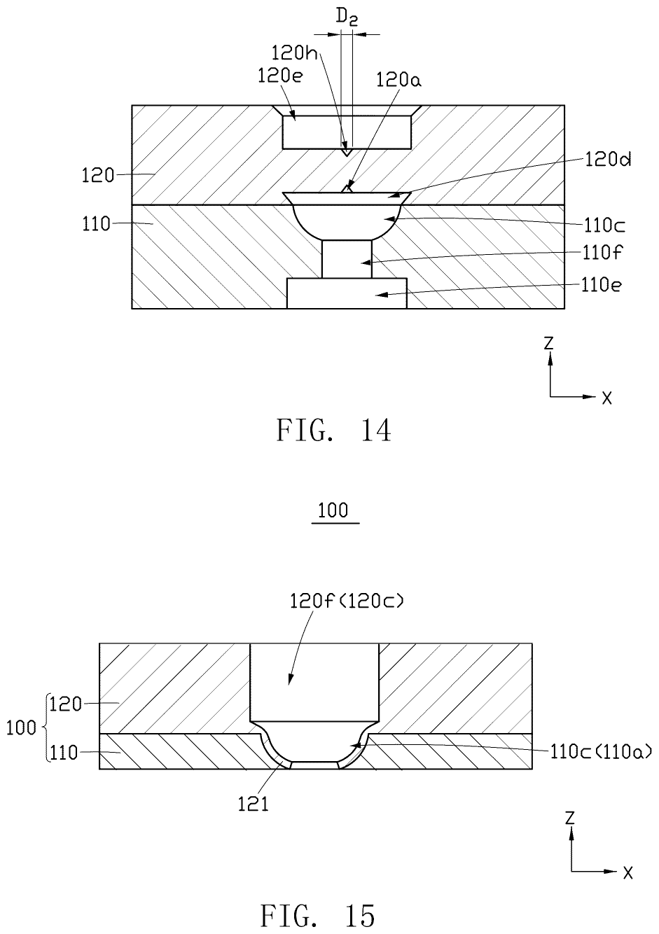

S143, referring to FIG. 14, a guiding hole 120h is define on the bottom surface of the sidewall-inclining hole 120e based on the traction hole 120a.

Referring to FIG. 14, the guiding hole 120h is located on the bottom surface of the vertical hole segment of the sidewall-inclining hole 120e. The guiding hole 120h is an inverted conical blind groove. A sharp-edged knife may be used to define the guiding hole 120h at step S143.

The guiding hole 120h is defined based on the traction hole 120a, indicating the central axis of the traction hole 120a being the reference for defining the guiding hole 120h, so that the central axis of the processed guiding hole 120h is aligned with the central axis of the traction hole 120a. Thus, the internal stress of the second metal layer 120 may be reduced, and the second metal layer 120 may uniformly crack from the traction hole 120a during the hot melt drilling.

Referring to FIG. 14, in some embodiments, a maximum diameter of the guiding hole 120h is equal to D₂, and 0.5 mm≤D₂≤1.0 mm. For example, D₂ may be about 0.5 mm, 0.6 mm, 0.7 mm, 0.8 mm, 0.9 mm, or 1.0 mm. Optionally, D₂ is about 1.0 mm.

By setting the maximum diameter of the guiding hole 120h, the guiding hole 120h may provide uniform guiding force for the second metal layer 120, thereby allowing the bottom surface of the sidewall-inclining hole 120e to uniformly crack during the hot melt drilling.

S144, based on the guiding hole 120h, the hot melt drilling is performed on the bottom surface of the sidewall-inclining hole 120e toward the first through hole 10a, thereby causing the bottom surface of the sidewall-inclining hole 120e to crack toward an opening of the traction hole 120a. Thus, the hot melt drilling hole 120f is formed, at least a portion of the bottom surface of the sidewall-inclining hole 120e is melted, and the melted portion is squeezed toward the curved hole segment 110c to form the bushing 121 that adheres to the sidewall of the curved hole segment 110c. A portion of the sidewall of the hot melt drilling hole 120f is the bushing 121. Then, the metal composite structure 100 is obtained. At this time, the cross-sectional view of the metal composite structure 100 is shown in FIG. 4A.

In some embodiments, the step S144 may be performed by a drill bit of the hot melt drilling equipment. Optionally, the hot melt drilling equipment includes a spindle, an ultrasonic fixture, and the drill bit connected in sequence. The drill bit performs hot melt drilling on the bottom surface of the sidewall-inclining hole 120e under the high-speed rotation of the spindle and the ultrasonic waves from the ultrasonic fixture.

In some embodiments, the rotation speed of the drill bit may be about 1800-2000 rpm, and the feeding speed of the drill bit along the axial direction may be about 15-20 mm/min. During the hot melt drilling process, air may be blown toward the drill bit to dissipate heat from the drill bit, and a cutting fluid is undesired for cooling. The hot melt drilling through hole 120f may be formed through a single feed or multiple feeds of the drill bit. After each feed, a pause of at least three seconds is needed to cool the drill bit, thereby avoiding excessive temperature.

Referring to FIG. 11, in some embodiments, the processing method of the metal composite structure further includes the following step.

S145, the sidewall of the second through hole 120c is milled.

A toroidal cutter may be used to mill the sidewall of the second through hole 120b, thereby removing burrs on the sidewall of the second through hole 120b.

In some embodiments, the central axis of the traction hole 120a, the central axis of the curved hole segment 110c, and the central axis of the basic hole segment 110b are aligned with each other. Therefore, when at least a portion of the bottom surface of the sidewall-inclining hole 120e is melted to form a bushing 121 during the hot melt drilling process, the internal stress of the bottom surface of the sidewall-inclining hole 120e may be uniformly released during the hot melt drilling process, and recesses or cracks may be avoided at the surface of the bushing 121.

Referring to FIG. 1, in some embodiments, in some embodiments, the processing method of the metal composite structure further includes the following step.

S150, referring to FIG. 15, the outer surfaces of the first metal layer 110 and the second metal layer 120 are milled to remove the sidewall-inclining hole 120e, the observation hole 110e, and the retraction hole 110f.

A milling cutter is used to mill the outer surface of the first metal layer 110, thereby removing the observation hole 110e and the retraction hole 110f, while the curved hole segment 110c being remained. In another embodiment, a portion of the curved hole segment 110c may be further removed, so that the thickness of the first metal layer 110 after milling may be reduced to 0.7 mm to 1 mm. Optionally, the thickness of the first metal layer 110 after milling is about 0.8 mm. At this time, the height of the bushing 121 extending into the curved hole segment 110c in the Z direction is about 0.8 mm.

The milling cutter is further used to mill the outer surface of the second metal layer 120 to remove the sidewall-inclining hole 120e, while the hot melt drilling hole 120f being remained. In another embodiment, a portion of the drilled through holes 120f may be further removed, and the thickness of the second metal layer 120 after milling may be reduced to 1.2 mm to 1.6 mm. Optionally, the thickness of the second metal layer 120 after milling is about 1.4 mm.

Referring to FIGS. 4A and 4B, a metal composite structure 100 is provided according to an embodiment of the present application. The metal composite structure 100 includes a first metal layer 110 and a second metal layer 120 stacked on the first metal layer 110. The first metal layer 110 defines a first through hole 110a. The first through hole 110a includes a curved hole segment 110c. The second metal layer 120 defines a second through hole 120c formed by hot melt drilling, and a portion of the second metal layer 120 forms a bushing 121 during the hot melt drilling. The bushing 121 adheres to the sidewall of the curved hole segment 110c.

Referring to FIGS. 4A, in some embodiments, the maximum diameter of the curved hole segment 110c along the X direction is 2.07 mm to 2.27 mm. For example, the maximum diameter of the curved hole segment 110c may be about 2.07 mm, 2.17 mm, or 2.27 mm. In other embodiments, the maximum diameter of the curved hole segment 110c may also be adjusted to allow the bushing 121 to fully cover thereon, thereby obtaining a waterproof hole.

In some embodiments, the diameter of the curved hole segment 110c gradually decreases from the boundary between the first metal layer 110 and the second metal layer 120 toward the outer surface of the second metal layer 120. The depth of the curved hole segment 110c is 1.0 mm to 1.3 mm. For example, the depth of the curved hole segment 110c may be about 1.0 mm, 1.15 mm, 1.25 mm, or 1.3 mm.

In some embodiments, in the metal composite structure 100, the first through hole 110a further includes an observation hole 110e and a retraction hole 110f connected to the observation hole 110e. The retraction hole 110f is further connected to the curved hole segment 110c. The diameter of the curved hole segment 110c is smaller than that of the observation hole 110e and larger than that of the retraction hole 110f.

In some embodiments, the diameter of the retraction hole 110f is denoted as D₁, and 1.5 mm≤D₁≤1.6 mm. For example, D₁ may be about 1.5 mm or 1.6 mm. Optionally, D₁ is about 1.5 mm. The depth of the retraction hole 110f is 0.7 mm to 0.9 mm. For example, the depth of the retraction hole 110f may be about 0.7 mm, 0.8 mm, or 0.9 mm.

In some embodiments, in the metal composite structure 100, the second through hole 120c includes a sidewall-inclining hole 120e and a hot melt drilling hole 120f connected to the sidewall-inclining hole 120e. The hot melt drilling hole 120f is further connected to the curved hole segment 110c. A portion of the sidewall of the hot melt drilling hole 120f is the bushing 121 that adheres to the curved hole segment 110c.

Referring to FIG. 13, in some embodiments, in the metal composite structure 100, the depth of the sidewall-inclining hole 120e is denoted as H₂, and 0.60 mm≤H₂≤0.70 mm. For example, H₂ may be about 0.60 mm, 0.65 mm, or 0.70 mm. Optionally, H₂ is about 0.60 mm.

In some embodiments, in the metal composite structure 100, the first metal layer 110 comprises aluminum alloy, and the second metal layer 120 comprises titanium alloy.

In some embodiments, the metal composite structure 100 is obtained by the processing method mentioned above. The metal composite structure 100 may be in form of a strip, and multiple metal composites 100 are connected to each other by injection molding or welding to form a frame. The second through hole 120c may be a sound hole or a button hole.

Referring to FIG. 15, in some embodiments, the first through hole 110a of the metal composite structure 100 includes only the curved hole segment 110c but without the observation hole 110e and the retraction hole 110f. The observation hole 110e and the retraction hole 110f may be removed at the step S150 mentioned above. The second through hole 120c of the metal composite structure 100 includes only the hot melt drilling through hole 120f but without the sidewall-inclining hole 120e. The sidewall-inclining hole 120e may be removed at step S150 mentioned above.

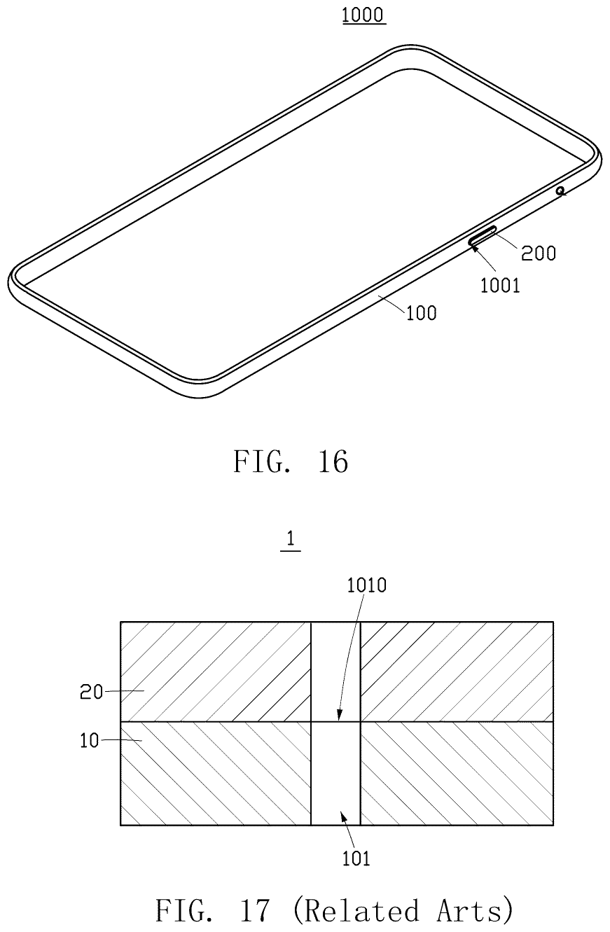

Referring to FIG. 16, a metal frame 1000 is provided according to an embodiment of the present application. The metal frame 1000 includes the metal composite structure 100 mentioned above. The metal frame 1000 further includes a button 200, a button groove 1001 is defined in the metal composite structure 100, the first through hole is defined in the bottom surface of the button groove 1001. The button 200 is put on button groove 1001, the button 200 has a protrusion, and the protrusion is installed in the hot melt drilling hole 120f and extends toward the curved hole segment 110c. The hot melt drilling hole 120f may be circular, square, rectangular, or elliptical. The shape of the button groove 1001 may be selected according to the shape of the button 200, and the hot melt drilling hole 120f may be obtained by multiple feeds of a cutting tool.

An electronic device (not shown) is further provided according to an embodiment of the present application. The electronic device includes the metal frame 1000 mentioned above. The electronic device may be a mobile phone, a tablet computer, a watch, or a wristband.

In the metal composite structure 100, the processing method, the metal frame 1000, and the electronic device of the present application, before the hot melt drilling is performed on the second metal layer 120, the traction hole 120a is first formed on the surface of the second metal layer 120 facing the first through hole 110a. The traction hole 120a may reduce the internal stress of the second metal layer 120, such that when a portion of the second metal layer 120 may be melted to form the bushing 121 that uniformly adheres to the sidewall of the first through hole 110a, recesses or cracks may be avoided at the surface of the bushing 121. Due to the bushing 121, liquid and dust are prevented from entering the boundary between the first metal layer 110 and the second metal layer 120 through the first through hole 110a or the second through hole 120b, and cracking at the boundary may be avoided. Thus, the sealing performance and the quality of the metal composite structure 100 is improved.

The above embodiments are only for describing but not intended to limit the present disclosure. Although the embodiments of the present disclosure have been described, those having ordinary skill in the art can understand that changes may be made within the principles of the present disclosure, up to and including the full extent established by the broad general meaning of the terms used in the claims. It will, therefore, be appreciated that the embodiments described above may be modified within the scope of the claims.

What is claimed is:

1. A processing method of a metal composite structure including a first metal layer and a second metal layer stacked on the first metal layer, the processing method comprising:
defining a first through hole in the first metal layer;
drilling in the first through hole toward the second metal layer to form a traction hole in the second metal layer; and
performing hot melt drilling on a surface of the second metal layer away from the first metal layer toward the first through hole, thereby causing the second metal layer to crack under a traction force of the traction hole to form a second through hole, and a portion of the second metal layer to be melted and squeezed to form a bushing which adheres to at least a portion of a sidewall of the first through hole, thereby obtaining the metal composite structure.

2. The processing method of claim 1, wherein defining the first through hole in the first metal layer comprises:
defining an original through hole on a surface of the first metal layer away from the second metal layer through a first cutting tool;
enlarging a portion of the original through hole near the second metal layer through a second cutting tool, thereby forming a curved hole segment at the portion of the original through hole near the second metal layer, and a remaining portion of the original through hole forming a basic hole segment, wherein the curved hole segment and the basic hole segment are connected to each other to form the first through hole, and
a diameter of the curved hole segment is greater than a diameter of at least a portion of the basic hole segment, and the diameter of the basic hole segment is equal to a diameter of the original hole segment.

3. The processing method according to claim 2, wherein defining the first through hole in the first metal layer further comprises:
enlarging a portion of the basic hole segment near the surface of the first metal layer away from the second metal layer to form an observation hole, and a remaining portion of the basic hole segment forming a retraction hole, wherein the retraction hole, the curved hole segment, and the observation hole are connected to each other to form the first through hole, the retraction hole is further connected to the curved hole segment, and
a diameter of the retraction hole is equal to the diameter of the base hole segment.

4. The processing method according to claim 3, wherein the diameter of the retraction hole is denoted as D₁, and 1.5 mm≤D₁≤1.6 mm.

5. The processing method according to claim 2, further comprising:
defining a first reference blind hole on a surface of the second metal layer facing the first metal layer through the original through hole.

6. The processing method according to claim 5, further comprising:
inserting the second cutting tool through the curved hole segment, and enlarging the first reference blind hole through the second cutting tool to form a dovetail hole.

7. The processing method according to claim 6, wherein a sum of a depth of the dovetail hole and a depth of the curved hole segment is denoted as H₁, 1.15 mm≤H₁≤1.25 mm, and the depth of the dovetail hole is smaller than the depth of the curved hole segment.

8. The processing method according to claim 6, wherein drilling in the first through hole toward the second metal layer to form the traction hole in the second metal layer comprises:
inserting a third cutting tool sequentially through the base hole segment and the curved hole segment, and defining the traction hole on a bottom surface of the dovetail hole.

9. The processing method of claim 2, wherein performing the hot melt drilling on the surface of the second metal layer away from the first metal layer toward the first through hole comprises:
drilling on the surface of the second metal layer away from the first metal layer toward the first through hole to form a second reference blind hole;
chamfering at least a portion of a sidewall of the second reference blind hole to form a sidewall-inclining hole;
based on the traction hole, defining a guiding hole on a bottom surface of the sidewall-inclining hole; and
based on the guiding hole, performing the hot melt drilling on the bottom surface of the sidewall-inclining hole toward the first through hole, thereby causing the bottom surface of the sidewall-inclining hole to crack toward an opening of the traction hole to form a hot melt drilling hole, wherein the sidewall-inclining hole and the hot melt drilling hole are connected to each other to form the second through hole, and at least a portion of the bottom surface of the sidewall-inclining hole is melted and squeezed to form the bushing which adheres to a sidewall of the curved hole segment.

10. The processing method according to claim 9, wherein a depth of the sidewall-inclining hole is denoted as H₂, and 0.6 mm≤H₂≤0.7 mm.

11. The processing method according to claim 9, wherein each of a maximum diameter of the traction hole and a maximum diameter of the guiding hole is denoted as D₂, and 0.5 mm≤D₂≤1.0 mm.

12. The processing method according to claim 2, further comprising:
milling a sidewall of the second through hole.

13. The processing method according to claim 2, wherein a central axis of the traction hole, a central axis of the curved hole segment, and a central axis of the base hole segment are aligned with each other.

14. A metal composite structure obtained by the processing method according to claim 1, the metal composite structure comprising:
a first metal layer defining a first through hole, the first through hole comprising a curved hole segment; and
a second metal layer stacked on the first metal layer, wherein the second metal layer defines a second through hole by hot melt drilling on the second metal layer, a portion of the second metal layer forms a bushing during the hot melt drilling, and the bushing adheres to a sidewall of the curved hole segment of the first through hole.

15. The metal composite structure of claim 14, wherein the first through hole comprises an observation hole and a retraction hole connected to the observation hole, the retraction hole is further connected to the curved hole segment, and a diameter of the curved hole segment is smaller than a diameter of the observation hole and is larger than a diameter of the retraction hole.

16. The metal composite structure according to claim 15, wherein the diameter of the retraction hole is denoted as D₁, and 1.5 mm≤D₁≤1.6 mm.

17. The metal composite structure of claim 14, wherein the second through hole comprises a sidewall-inclining hole and a hot melt drilling hole connected to the sidewall-inclining hole, the hot melt drilling hole is further connected to the curved hole segment, and a portion of a sidewall of the hot melt drilling hole is the bushing which adheres to the sidewall of the curved hole segment.

18. The metal composite structure according to claim 17, wherein a depth of the sidewall-inclining hole is denoted as H₂, and 0.6 mm≤H₂≤0.7 mm.

19. The metal composite structure of claim 17, wherein the first metal layer comprises aluminum alloy, and the second metal layer comprises titanium alloy.

20. A metal frame comprising:
a metal composite structure comprising:
a first metal layer defining a first through hole, the first through hole comprising a curved hole segment; and
a second metal layer stacked on the first metal layer, wherein the second metal layer defines a second through hole by hot melt drilling on the second metal layer, a portion of the second metal layer forms a bushing during the hot melt drilling, and the bushing adheres to a sidewall of the curved hole segment of the first through hole.
